(19) United States
(12) Patent Application Publication
(10) Pub. No.: US 2026/0274556 A1
(43) Pub. Date: Sep. 17, 2026

(54) SILO, STABILISATION DEVICE AND METHOD FOR STABILISATION OF CHARCOAL

(71) Applicant: VALLOUREC SOLUÇÕES TUBULARES DO BRASIL S.A., Belo Horizonte - MG (BR)

(72) Inventors: Lucas DE FREITAS FIALHO, Curvelo - MG (BR); Joao Carlos FERREIRA DA SILVA, Curvelo - MG (BR)

(73) Assignee: VALLOUREC SOLUÇÕES TUBULARES DO BRASIL S.A., Belo Horizonte - MG (BR)

(21) Appl. No.: 19/167,669

(22) PCT Filed: Apr. 3, 2024
(86) PCT No.: PCT/BR2024/050140

§ 371 Date: Sep. 22, 2025

(30) Foreign Application Priority Data
Apr. 4, 2023 (BR) 1020230063039

(51) Int. Cl. B65D 88/74; B65D 88/08; B65D 88/28; C10B 57/00

(52) U.S. Cl. CPC B65D 88/741; B65D 88/08; B65D 88/28; B65D 88/745; C10B 57/00; B65D 2588/743

(57) ABSTRACT

A silo for stabilisation of charcoal includes a wall defining an internal space for storing the charcoal, an upper aperture defined by an upper extremity of the wall and arranged to receive the charcoal when the charcoal is falling under gravity from above the silo to the internal space, a lower aperture including a blocking state to block charcoal in the silo and an open state to permit a discharge of charcoal from the silo, a plurality of lateral apertures distributed regularly about a longitudinal axis of the silo, and a conical top. The plurality of lateral apertures can be connected to a gas flow dispenser to inject gas flow into the internal space. An upper extremity of the conical top is aligned with the upper aperture to ensure a homogenous fall of the charcoal into the internal space through the upper aperture.

### BACKGROUND OF THE INVENTION

The present invention relates to the production of charcoal and, more specifically, to the stabilisation of charcoal.

The production of charcoal is the thermochemical process of conversion of lignocellulosic materials into charcoal. The process of charcoal production consists of three principal stages, these being a stage of drying lignocellulosic materials, a stage of pyrolysis of dry lignocellulosic materials to produce charcoal, and a stage of cooling the said charcoal.

One of the great challenges in charcoal production is that, even following the cooling stage, sources of fire still occur in the charcoal obtained which may cause diverse damage. The majority of these sources of fire are caused by the incorrect stabilisation of the pyrolysis reactions (exothermic thermochemical reactions), which will consequently generate heat, leading to the ignition of the charcoal produced.

In fact, even following cooling, the charcoal remains reactive by virtue of exothermic reactions causing the ignition of the product during storage and/or transport.

It is known that the process of stabilisation of charcoal was realised through depositing charcoal for stabilisation in a yard exposed to the weather for in excess of 48 hours. This process is of low efficiency, presenting possible occurrences of ignition of the charcoal in the yard, storage and/or transport.

In order to resolve this problem of ignition in the charcoal, by virtue of the low efficiency of stabilisation of the charcoal following cooling, the necessity arises for a more efficient stabilisation device and a rapid process of stabilisation with the objective of stabilising the thermochemical reactions of the pyrolysis and removing any heat which may be generated during the process.

### SUMMARY OF THE INVENTION

Consequently, a first non-exclusive objective of the invention is the provision of a silo for charcoal stabilisation, the said silo comprising:
a wall defining an internal space for storing the said charcoal,
an upper aperture arranged to receive the said charcoal when the said charcoal falls under gravity from above the silo to the internal space,
a lower aperture, said lower aperture having:
   a blocking state to block the charcoal in the silo, and
   an open state to permit the discharge of charcoal from the silo,

the silo comprising a plurality of lateral apertures, the said lateral apertures being distributed regularly about a longitudinal axis of the silo, the plurality of lateral apertures being configured to be connected to a gas flow dispenser in order to inject a gas flow into the internal space,

the silo furthermore comprising a conical top, an upper extremity of the said conical top being aligned with the upper aperture in order to ensure homogenous dropping of charcoal into the internal space through the upper aperture.

By virtue of these characteristics the charcoal may be stabilised easily and within a limited period of time. In particular, the silo according to these characteristics ensures homogenous stabilisation of the charcoal. This homogenous stabilisation of the charcoal requires a short processing time in order to ensure the stabilisation of all the charcoal stored in the internal space.

The lateral apertures distributed regularly about the longitudinal axis of the silo ensure that the gas flows entering into the internal space through the said lateral apertures are homogenous, in this manner ensuring homogenous stabilisation of the charcoal.

In addition thereto, the upper aperture ensures that the gas flowrates injected into the internal space by the lateral apertures be expelled naturally from the silo through the internal space to the upper aperture.

The conical top creates a path for the charcoal to fall under gravity from above the silo into the internal space through the upper aperture, this path ensuring a homogenous distribution of the said charcoal within the internal space.

The homogenous distribution of the charcoal within the internal space and the regular distribution of the lateral apertures about the longitudinal axis of the silo ensure homogenous stabilisation of the charcoal stored in the silo, providing reliable stabilisation of the charcoal within a limited period of time.

Such silo for charcoal stabilisation may comprise one or more of the resources below, singly or in combination.

The wall may have different forms in order to define the internal space. In one embodiment, the wall has a cylindrical shape. In another embodiment, the wall has a troncoconical shape. Such cylindrical or troncoconical shapes have, for example, a circular base, a square base or any other shape of base.

Furthermore the most diverse construction materials may be utilised for the silo, such as steel, masonry, etc.

The upper aperture may also have different forms.

In a preferred embodiment, the upper aperture has a shape identical to the shape of the internal space. This shape, identical between the upper aperture and the internal space, ensures that the charcoal passing through the upper aperture can be homogenously distributed within the internal space.

The upper aperture has, for example, a circular shape, a square shape or any other shape.

The conical top may also have different shapes.

Preferably, the base of the conical top has a shape identical to the shape of the upper aperture. This identical shape ensures homogenous distribution of charcoal falling upon the conical top from or to the upper aperture.

In a preferred embodiment, the conical top is centralised with the upper aperture. In a preferred embodiment, the upper aperture is coaxial with the wall defining the internal space.

For example, if the upper aperture and the conical top both have a circular shape, then they are perfectly coaxial. In particular, in one embodiment, both the conical top and the upper aperture are coaxial with the wall defining the internal space. In this embodiment, the wall, the upper aperture and the conical top preferentially have a circular shape.

In one embodiment the conical top is disposed above the upper aperture.

In one embodiment, the conical top is disposed between the upper aperture and the lower aperture. In one embodiment, the conical top is disposed within the internal space of the silo for storing charcoal. In this embodiment, the comical top is preferentially disposed within the upper portion or within the internal space, for example within the upper 10% of the wall, that is to say, proximate to the upper aperture.

In one embodiment, the silo comprises arms extending from an internal surface of the wall toward the longitudinal axis of the silo, these arms joining the conical top and the wall.

In one embodiment, the silo comprises three arms regularly distributed about the longitudinal axis of the silo, the said three arms joining the internal surface of the wall and the conical top.

The conical top may have various arrangements in the silo. In one embodiment, the conical top extends between 15% and 50%, preferentially between 20% and 30%, from the surface in a plane perpendicular to the longitudinal axis of the silo, from the upper aperture.

According to one embodiment, the plurality of lateral apertures is disposed in the lower half of the silo, the said lower half of the silo comprising the lower aperture.

In one embodiment, the plurality of lateral apertures is disposed in the lower 25% of the silo, and more preferentially in the lower 10% of the silo, that is to say 25%, respectively 10%, of the silo from the lower aperture toward the upper aperture.

Such disposition of the lateral aperture ensures that the gas flow injected through the lateral apertures flows out through the upper aperture, passing through the entire internal space. This exhaustion of the gas flow passing through the entire internal space ensures complete and homogeneous stabilisation of the charcoal stored within the interior of the space.

In one embodiment, the silo comprises at least three lateral apertures, and preferentially four apertures. Preferably, the lateral apertures are distributed uniformly about the longitudinal axis of the silo, for example distributed circumferentially about the longitudinal axis of the silo in the case of a circular wall. For example, these lateral apertures are distributed about the longitudinal axis of the silo at an angle of 120°in the case of a silo having three lateral apertures, or at an angle of 90°, in the case of a silo having four lateral apertures.

According to one embodiment, the upper aperture is defined by an upper extremity of the wall.

In other words, the silo is preferentially completely open in the upper portion thereof, the upper aperture in this case de facto having the same shape as the internal space.

Such upper aperture defined by the wall extends above the entire internal space and does not limit the outflow of the gas flow to a single path, the outflow of the gas escapes in a homogenous manner from the internal space and ensures homogeneous stabilisation of the charcoal. Furthermore, such a completely open silo is easy to manufacture. Furthermore, such a completely open silo in operation is proximate to atmospheric pressure, being easy to monitor.

In one embodiment, the silo comprises a cover, the said cover extending from the upper extremity of the wall toward the longitudinal axis of the silo, the said cover comprising the upper aperture.

According to one embodiment, the silo comprises a communication ring, the said communication ring surrounding the wall about the longitudinal axis of the silo, said communication ring comprising an external aperture configured to be connected to the gas flow dispenser, the communication ring defining a communication space between the external aperture and the lateral apertures.

Such communication ring ensures a homogenous feed of gas from the lateral apertures and, consequently, the homogenous input gas flows through the lateral apertures, homogenously stabilising the charcoal within the internal space.

According to one embodiment, the silo has an upper portion and a lower portion, the upper portion being defined by the wall, the lower portion having a conical shape, a section of the lower portion diminishing from the upper portion until the end of the lower portion opposed to the said upper portion, the extremity of the lower portion comprising the lower aperture.

Such lower portion having a conical shape ensures a homogenous discharge of charcoal through the lower aperture. Consequently, it is possible to solely partially discharge the silo whilst the bed of stabilised charcoal held in the silo forms a planar surface to receive more unstabilised charcoal. Such planar bed of stabilised charcoal ensures that the unstabilised charcoal added not be mixed with the already stabilised charcoal when added. Consequently, a subsequent partial discharge from the silo will firstly supply the already stabilised charcoal, that is to say, that in a state of homogenous stabilisation of the said charcoal.

Preferentially, the lower portion has a shape corresponding to the shape of the upper portion. In other words, if the upper portion defined by the wall has a circular cylindrical shape, then the lower portion will have a circular conical shape. The internal space for storing the charcoal is defined both by the upper portion and by the lower portion, that is to say, both by the wall and by the conical lower portion, between the upper and lower apertures.

In one embodiment, the communication ring surrounds the lower portion of the silo.

According to one embodiment, the conical shape of the lower portion has an angle with the longitudinal axis of the silo of between 40° and 60°. In a preferred embodiment, the conical shape of the lower portion has an angle with the longitudinal axis of the silo of between 45° and 55°. For example, the conical shape of the lower portion has an angle with the longitudinal axis of the silo of 52°. Such angles ensure that the charcoal discharged from the silo through the bottom aperture is discharged in a homogenous manner and that there are no dead charcoal discharge zones in the silo, that is to say, zones in the silo wherein the charcoal is blocked during discharge.

Such angle for the conical lower portion provides easy discharge under gravity of the charcoal stored in the silo.

According to one embodiment, the plurality of lateral apertures comprises a first plurality of lateral apertures and a second plurality of lateral apertures, the first plurality of lateral apertures being regularly distributed about the longitudinal axis of the silo on a first plane perpendicular to the longitudinal axis of the silo, the second plurality of lateral apertures being distributed regularly about the longitudinal axis of the silo in a second plane perpendicular to the longitudinal axis of the silo. Preferentially, the first plane and the second plane are disposed at different levels.

These first and second pluralities of lateral apertures disposed at different levels in the silo ensure good injections of gas flows within the silo. In particular, these first and second pluralities of lateral apertures ensure that the gas flows injected through the lateral apertures escape passing through the entire internal space.

In one embodiment, the first plane intersects the lower portion of the silo. In one embodiment, the second plane intersects the lower portion of the silo.

In one embodiment, the first plane and/or the second plane intersect the wall. In this case, the first plane and/or the second plane intersect the wall in a lower portion of the wall, that is to say, close to the lower aperture.

In one embodiment, the first plane and/or the second plane intersect the lower half of the wall, the said lower half of the wall being the portion of the wall most proximate to the lower aperture.

More preferentially, the first plane and/or the second plane intersect the wall in the lower 25% of the wall, and more preferentially in the lower 10% of the wall, that is to say, the 25%, respectively 10%, of the wall being the most proximate to the lower aperture.

According to one embodiment, the silo comprises a first communication ring surrounding the longitudinal axis of the silo in the first plane, the said first communication ring comprising a first external aperture configured to be connected to a flow dispenser, the first communication ring defining a first communication space between the first external aperture and the first lateral apertures, the silo furthermore comprising a second communication ring surrounding the longitudinal axis of the silo in the second plane, the said second communication ring comprising a second external aperture configured to be connected to the flow dispenser, the second communication ring defining a second communication space between the second external aperture and the second lateral apertures.

In one embodiment, the first communication space and the second communication space are joined. For example, a tube joining the first external aperture or the second external aperture to the second communication space or to the first communication space, respectively. In other words, one out of the first external aperture or the second external aperture is configured to be indirectly connected to a flow dispenser through, respectively, the second communication or the first communication ring.

According to one embodiment, the silo furthermore comprises a temperature monitoring system.

Such temperature monitoring system comprises at least one temperature sensor to monitor the temperature of the charcoal stored in the internal space of the silo.

Another aspect of the invention provides a stabilisation device for charcoal comprising:
a silo as detailed above,
a charcoal loading device configured to discharge charcoal for stabilisation under gravity from above the silo to the internal space, a path of the discharged charcoal passing via the upper extremity of the conical top, and
a gas flow dispenser connected to the plurality of lateral apertures.

According to the disposition of the lateral apertures, for example, the silo comprising or not communication rings, the gas flow dispenser may be connected directly or indirectly to the lateral apertures.

A further aspect of the invention provides a method for stabilisation of the charcoal comprising:
providing a stabilisation device as detailed above,
discharging charcoal for stabilisation from the charcoal loading device to the internal space of the silo,
injecting the gas flow into the internal space from the gas flow dispenser through the lateral apertures.

In a preferred embodiment of the present invention, the gas flow is injected into the internal space at a flow rate of at least 1.2 Nm³ of air per kg of charcoal per hour.

Such flow of air ensures homogenous flows and natural correct exhaustion of the air through the upper aperture of the silo, being sufficient to stabilise the charcoal, that is to say, removing all the heat in order to prevent any ignition.

The gas used to stabilise the charcoal is a non-combustible gas. This gas is, for example, atmospheric air at ambient temperature, this atmospheric air being easy to supply to the internal space, for example, using a blower as gas flow dispenser. Nevertheless, such non-combustible gas may be, for example, CO₂, N₂, or any other non-combustible gas.

### BRIEF DESCRIPTION OF THE DRAWINGS

The characteristics and advantages of the invention shall be better understood having in view the description of the following embodiments of the invention making reference to the annexed drawings, wherein:

FIG. 1 is a schematic drawing of a stabilisation device for charcoal stabilisation according to one embodiment of the invention,

FIG. 2 is a schematic drawing of a silo according to the invention,

FIG. 3 is a longitudinal cross-sectional view of a silo according to the invention,

FIG. 4 is a radial cross-sectional view of a silo of FIG. 3 at the level of a plurality of lateral apertures,

FIG. 5 is a schematic drawing of a side view of a lower portion of the silo of FIG. 3.

By convention, the terms “outer” or “external” and “inner” or “internal” are used to define the relative position of one element in relation to another or to the orientation of such element, with reference to a longitudinal axis X of the silo, an element or a surface proximate to/facing toward the longitudinal axis X being qualified as “internal” and an element or surface distant from/facing away from the longitudinal axis X being qualified as “external”. The radial direction is defined as being perpendicular to the longitudinal axis X of the silo.

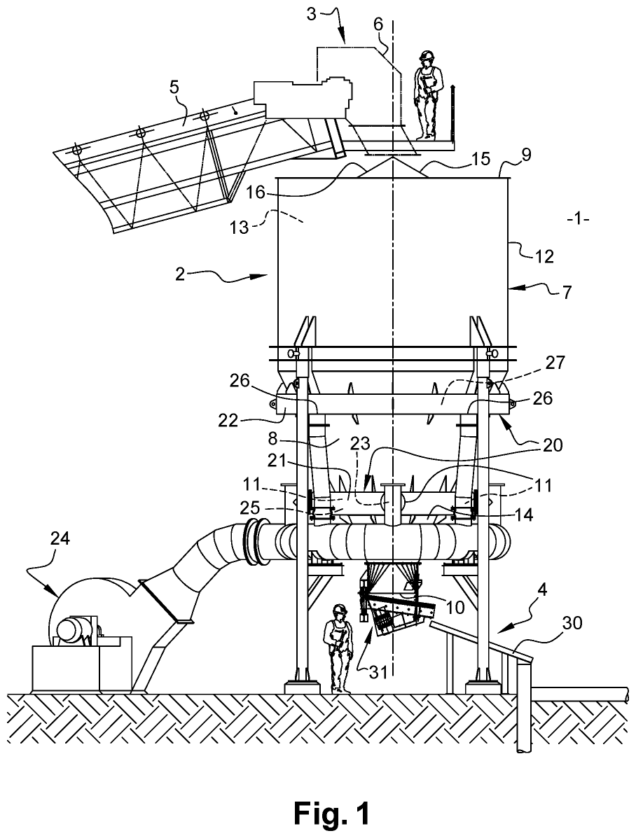

FIG. 1 shows a stabilisation device 1 for stabilisation of charcoal, comprising a silo 2, a charcoal loading device 3 and a charcoal distributing device 4.

The charcoal loading device 3 comprises a conveyor belt 5 carrying the charcoal for stabilisation to a charcoal distributor 6 of the charcoal loading device 3. The charcoal distributor 6 is disposed above the silo 3 such that, as explained below, the charcoal for stabilisation arising from the conveyor belt 5 falls under gravity into the silo 3 of the charcoal distributor 6.

Making reference to FIGS. 1 to 3, the silo comprises an upper portion 7, a lower portion 8, an upper aperture 9, a lower aperture 10 and lateral apertures 11.

The upper portion 7 comprises a wall 12. The said wall 12 defines an internal space 13 of the silo 2, permitting the said internal space 13 to store charcoal for stabilisation during the stabilisation process.

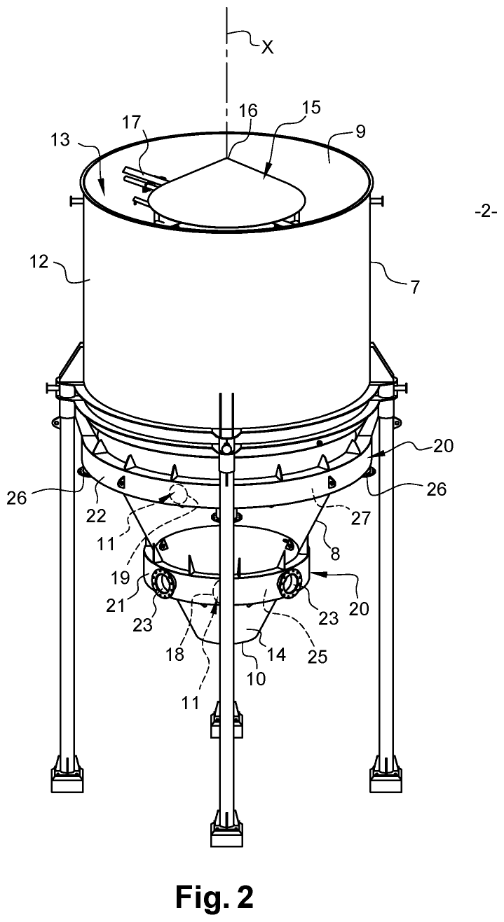

As shown in FIG. 2, the wall 12 has a circular shape defining a circular cylindrical internal space 13 about a longitudinal axis X of the silo 2. Such circular shape ensures a good natural distribution of the charcoal for stabilisation within the internal space 13.

The upper aperture 9 is defined by the wall 12. In other words, the upper portion 7 of the silo 2 is completely open and the upper aperture 9 has the same format as the wall 12. The charcoal dispenser 6 is disposed above the upper aperture 9 and is centred above the said upper aperture.

As shown in FIGS. 2, 3 and 5, the lower portion 8 has a troncoconical shape. One lower extremity 14 of the lower portion 8 is open and forms the lower aperture 10. The lower portion 8 extends in a decreasing cross-section below the upper portion 7. In particular, the lower portion 8 extends in a decreasing cross-section of the wall 12 to the lower aperture 10. Such troncoconical format of the lower portion 8 is preferentially inclined in relation to the longitudinal axis X at an angle of between 40° and 60°, more preferentially between 45° and 55°, and at an angle of 52° in the silo 2 shown in FIG. 1. Such angle ensures that the charcoal discharged from the silo through the lower aperture is discharged in a homogenous manner and that there are no dead charcoal discharge zones in the silo 2, that is to say, zones in the silo 2 wherein the charcoal is blocked when discharging.

Consequently, if the silo 2 is solely partially discharged, the charcoal remaining in the silo 2 forms a planar support for the charcoal subsequently loaded into the silo 2, and the charcoal added does not mix with the charcoal already stabilised and undischarged. This ensures that the charcoal subsequently discharged is homogeneously stabilised.

The lower aperture 10 possesses means of closure providing two states for the said lower aperture, a closed state, wherein the lower aperture 10 is closed and blocks the charcoal in the internal space 13, and an open state, wherein the charcoal stored in the internal space 13 is discharged from the silo under gravity through the lower aperture 10.

As shown in FIGS. 1 to 3, the silo 2 also comprises a conical top 15. In the embodiment shown in the figures, this conical top is disposed within the internal space 13. More specifically, the conical top 15 is disposed within the upper portion of the internal space 13. This conical top has a conical circular shape having an upper extremity 16 facing the charcoal distributor 6. The charcoal distributor 6 is disposed above the conical top 15 such that the charcoal falls under gravity from the carbon distributor 6 onto the upper extremity 16 of the conical top 15. By virtue of the conical format thereof and the disposition of the charcoal dispenser above the upper extremity 16 of the conical top 15, the conical top 15 ensures the homogeneous distribution of the charcoal within the internal space 13 below the said conical top 15.

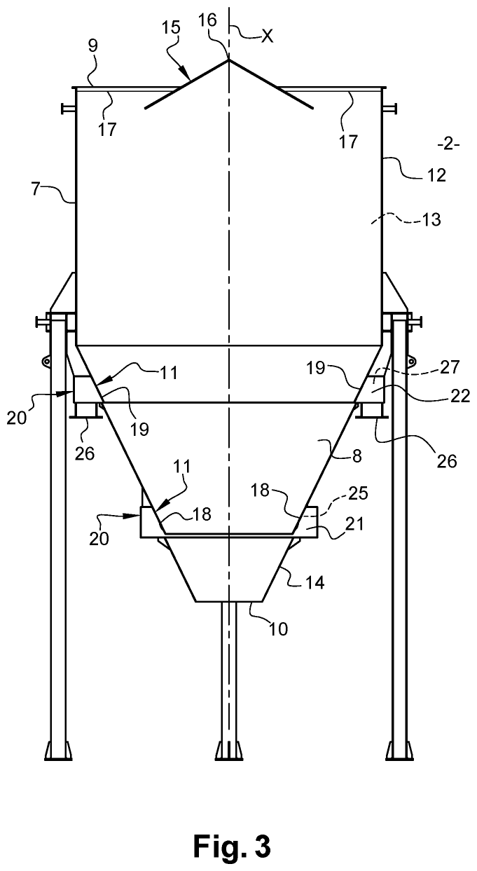

In the embodiment shown in FIGS. 2 and 3, the conical top 15 has a base diameter being one half of the diameter of the internal space 13 and is coaxial with the said internal space 13 for a better distribution of the charcoal in the internal space 13. The silo comprises three arms 17 joining an internal surface of the wall 12 and the lower extremity of the conical top 15, maintaining the said conical top 15 in position within silo 2. These arms 17 are distributed regularly about the longitudinal axis X of the silo.

In the embodiment shown in FIG. 2, the lateral apertures 11 comprise a first plurality of lateral apertures 18 and a second plurality of lateral apertures 19. The first plurality of lateral apertures 18 is disposed at the same level within silo 2 in a first plane perpendicular to the longitudinal axis X. The second plurality of lateral apertures 19 is disposed at the same level within silo 2 in a second plane perpendicular to the longitudinal axis X. Preferentially, the first plane and the second plane are at different levels, that is to say, they are parallel.

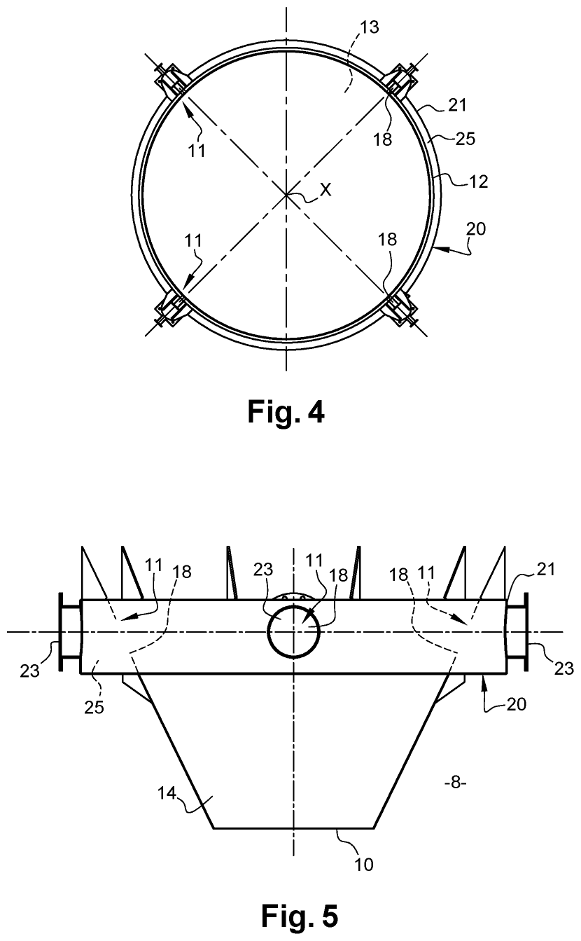

As shown in detail in FIG. 4, the lateral apertures 11 are distributed regularly about the longitudinal axis X. More specifically, the first plurality of lateral apertures 18 is distributed regularly about the longitudinal axis X in the first plane and the second plurality of lateral apertures 19 is regularly distributed about the longitudinal axis X in the second plane. In the embodiment shown in the figures, the first plurality of lateral apertures 18 comprises four lateral apertures 11 spaced at an angle of 90° in relation to those adjacent about the longitudinal axis X. In the same manner, the second plurality of lateral apertures 19 comprises four lateral apertures 11 spaced at an angle of 90° in relation to those adjacent about the longitudinal axis X.

The lateral apertures are preferentially disposed within the lower portion 8 of the silo 2 such that the gas flow entering into the internal space 13 through the lateral apertures 11 passes through the entire internal space 13 when the said gas flow is exhausted from the internal space 13 through the upper aperture 9.

The silo 2 furthermore comprises communication rings 20 about the lateral apertures 11. A first communication ring 21 surrounds the first plurality of lateral apertures 18 and a second communication ring 22 surrounds the second plurality of lateral apertures 19.

The first communication ring 21 comprises at least one first external aperture 23. The first external aperture 23 is connected to a gas flow dispenser 24. The gas flow dispenser 24 provides a gas flow to the first communication ring 21. The first communication ring 21 defines a first communication space 25, the said first communication space 25 ensuring that the gas flow arising from the gas flow dispenser 24 reaches the internal space 13 of the silo 2 through, successively, the first external aperture 23, the first communication space 25 and the first plurality of lateral apertures 18. This first communication ring 21 provides a homogeneous gas flow to the first plurality of lateral apertures 18 and, in consequence, homogeneous gas flows entering into the internal space 13 through the said first plurality of lateral apertures 18.

In the same manner, the second communication ring 22 comprises at least one second external aperture 26 and defines a second communication space 27. This at least one second external aperture 26 is directly connected to the flow dispenser in FIG. 1. Nevertheless, in an embodiment not shown, the at least one second external aperture 26 can be connected to the first communication space 25 through at least one communication aperture disposed in the first communication ring 21 and at least one communication tube joining at least one said second external aperture 26 and at least one said communication aperture. In this embodiment not shown, the second communication space 27 is indirectly connected to the flow dispenser 24 through the first communication space 25.

Preferentially, in the case of a plurality of first and/or second external apertures 23, 26, the said plurality of first and/or second external apertures 23, 26 are, respectively, regularly distributed about the longitudinal axis X of the silo 2.

In the same manner, in the case of the second communication space 27 being indirectly connected to the flow dispenser 24 through the first communication space 25, the plurality of corresponding communication apertures are preferentially also regularly distributed about the longitudinal axis X of the silo 2.

This ensures a homogeneous input gas flow within the first and/or second communication space 25, 27 and, consequently, a homogeneous input gas flow within the internal space 13 through the first and/or second plurality of lateral apertures 18, 19.

In an embodiment not shown, the second communication ring is directly connected to the gas flow dispenser through the second external aperture and the first communication ring is indirectly connected to the gas flow dispenser through the second communication space.

The charcoal distributor 4 is disposed below the lower aperture 10 in order to receive stabilised charcoal from the internal space 13 through the lower aperture 10. In FIG. 1, this charcoal distributor 4 comprises a second conveyor belt 30 to carry stabilised charcoal to a place of storage or a distribution device, for example, a lorry.

As shown in FIG. 1, a vibratory device 31 can be disposed in the silo 2 at the location of the lower aperture 10. Such vibratory device 31 permits that the discharge be homogeneous, ensuring that there are no “dead” zones within the silo 2 and is completely open to the atmosphere. This ensures simplicity of construction and operation.

As explained above, the principal objective of the stabilisation device 1 described below is to stabilise the charcoal, following the stages of pyrolysis and cooling, by flowing a non-flammable gas across a bed of charcoal for stabilisation stored within a silo, that is to say, in the internal space 13.

The process of charcoal stabilisation using the aforedescribed stabilisation device is detailed below.

A first stage of the process of stabilisation of the charcoal is filling the internal space 13 with charcoal for stabilisation. In order to fill the internal space 13 with charcoal for stabilisation, the said charcoal for stabilisation is carried by the conveyor belt 5 to the charcoal dispenser 6. Subsequently, the charcoal falls from the charcoal dispenser 6 upon the upper extremity 16 of the conical top 15. By virtue of the conical shape of the conical top 15, the charcoal is distributed homogenously from the upper extremity 16 to the internal space on falling into the internal space 13. The lower aperture 10 is in the closed state thereof to ensure that the stabilised charcoal remains stored in the internal space 13.

The internal space 13 having been filled, completely or partially, with charcoal for stabilisation, the gas flow dispenser 24 is actuated sending a gas flow to the lateral apertures 11. The communication rings 20 ensure that the gas flow is fed in a homogenous manner to the lateral apertures 11. Furthermore, the disposition of the lateral apertures 11 disposed regularly about the longitudinal axis X of the silo 2 ensures that the gas flow enters in a homogenous manner into the interior of the internal space 13 from the said lateral apertures.

The lower aperture 10 being in the closed state thereof, the gas flow exits naturally from the internal space 13 through the upper aperture 9. The silo 2 being completely open, by virtue of the fact that the upper aperture 9 is defined by the wall 12, the gas flow naturally exits homogeneously through the upper aperture 9. In fact, the completely open silo 2 does not create a single or specific path for the gas flow to escape. Furthermore, by virtue of the fact that the lateral apertures 11 are disposed in the lower portion 8 of the silo 2, the outflow of the flow of gas passes throughout the bed of charcoal until it is stabilised, ensuring the homogeneous stabilisation of all the charcoal stored in the internal space 13.

In order to ensure a good homogeneous and naturally guided exhaustion of the gas flow, the flowrates input into the internal space 13 of the lateral apertures 11 must be, preferentially, of at least 1.2 Nm³ of air per kg of charcoal per hour (1.2 Nm³/kg·h). This flowrate depends upon the size of the internal space and upon the quantity of charcoal for stabilisation.

This flow of air is important in order to ensure a homogeneous flow and correct exhaustion of the air through the upper aperture 9. Furthermore, this flow of air is sufficient in order to stabilise the charcoal (remove all the heat) in order to prevent any ignition.

The gas utilised to stabilise the charcoal may be any type of non-combustible gas. This gas is, for example, atmospheric air at the ambient temperature, this atmospheric air being easy to provide to the internal space 13, for example, using a blower as gas flow dispenser 24. Nevertheless, such non-combustible gas may be, for example, CO₂, N₂, or any other non-combustible gas.

The flow of non-combustible gas is maintained, for example, for a period of between 8 to 36 hours to ensure a good and homogenous stabilisation of the charcoal.

Then, finally, the stabilised charcoal may be, completely or partially, discharged through the lower aperture 10 to the charcoal distributor 4.

Although the invention has been described in conjunction with various particular modes of realisation, it is very clear that it is not in any manner restricted thereto and that it comprises all the technical equivalents of the means described and combinations of the same, when these fall within the scope of the invention as defined by the claims.

The use of the verbs “comprise”, “have” or “include” and conjugated forms thereof does not exclude the existence of elements or stages differing from those listed in a claim.

In the claims, any reference denotation within parentheses shall not be interpreted as limiting the claim.

1-12. (canceled)

13. A silo for stabilisation of charcoal, the silo comprising:
a wall defining an internal space for storing the charcoal;
an upper aperture defined by an upper extremity of the wall and arranged to receive the charcoal when the charcoal is falling under gravity from above the silo to the internal space, said upper aperture having a shape and dimension identical to the shape and dimension of the internal space;
a lower aperture, the lower aperture including
a blocking state to block charcoal in the silo, and
an open state to permit a discharge of charcoal from the silo;
a plurality of lateral apertures, the lateral apertures being distributed regularly about a longitudinal axis of the silo, the plurality of lateral apertures being configured to be connected to a gas flow dispenser to inject gas flow into the internal space; and
a conical top, an upper extremity of said conical top being aligned with the upper aperture to ensure a homogenous fall of the charcoal into the internal space through the upper aperture.

14. The silo for stabilisation of charcoal according to claim 13, wherein the plurality of lateral apertures is disposed in the lower half of the silo, the lower half of the silo comprising the lower aperture.

15. The silo for stabilisation of charcoal according to claim 13, wherein silo comprises a communication ring, the communication ring surrounding the wall about the longitudinal axis of the silo, the communication ring comprising an external aperture configured to be connected to the gas flow dispenser, the communication ring defining a communication space between the external aperture and the lateral apertures.

16. The silo for stabilisation of charcoal according to claim 13, wherein the silo includes an upper portion and a lower portion, the upper portion being defined by the wall, the lower portion including a conical format, a cross-section of the lower portion decreasing from the upper portion as far as an extremity of the lower portion opposed to the upper portion, the extremity of the lower portion comprising the lower aperture.

17. The silo for stabilisation of charcoal according to claim 16, wherein the conical shape of the lower portion is at an angle to the longitudinal axis of the silo of between 40° and 60°.

18. The silo for stabilisation of charcoal according to claim 13, wherein the plurality of lateral apertures comprises a first plurality of lateral apertures and a second plurality of lateral apertures, the first plurality of lateral apertures being regularly distributed about the longitudinal axis of the silo in a first plane perpendicular to the longitudinal axis of the silo, the second plurality of lateral apertures being regularly distributed about the longitudinal axis of the silo in a second plane perpendicular to the longitudinal axis of the silo.

19. The silo for stabilisation of charcoal according to claim 18, further comprising:
a first communication ring surrounding the longitudinal axis of the silo in the first plane, the first communication ring comprising a first external aperture configured to be connected to a flow dispenser, the first communication ring defining a first communication space between the first external aperture and the first lateral apertures; and
a second communication ring surrounding the longitudinal axis of the silo in the second plane, the second communication ring comprising a second external aperture configured to be connected to the flow dispenser, the second communication ring defining a second communication space between the second external aperture and the second lateral apertures.

20. The silo for stabilisation of charcoal according to claim 13, further comprising a temperature monitoring system.

21. A stabilisation device for charcoal, comprising:
the silo for stabilisation of charcoal according to claim 13;
a charcoal loading device configured to discharge the charcoal for stabilisation under gravity from above the silo to the internal space, a path of the discharged charcoal passing via the upper extremity of the conical top; and
a gas flow dispenser connected to the plurality of lateral apertures.

22. A method for stabilisation of charcoal, comprising:
providing the stabilisation device as defined in claim 21;
discharging the charcoal for stabilisation from the charcoal loading device to the internal space of the silo;
storing the charcoal to be stabilized in the internal space; and
injecting the gas flow into the internal space from the gas flow dispenser through the lateral apertures.

23. The method for stabilisation of charcoal according to claim 22, wherein the gas flow is injected into the internal space at a flow rate of at least 1.2 Nm³ of air per kg of charcoal per hour.
